(19) United States
(12) Patent Application Publication
(10) Pub. No.: US 2005/0021779 A1
(43) Pub. Date: Jan. 27, 2005

(54) Localized knowledge-based intelligent network

(76) Inventors: Syed V. Ahamed, Holmdel, NJ (US); Victor B. Lawrence, Holmdel, NJ (US)

Correspondence Address: DUANE MORRIS, LLP;IP DEPARTMENT, ONE LIBERTY PLACE, PHILADELPHIA, PA, 19103-7396, US

(21) Appl. No.: 10/425,384

(22) Filed: Apr. 29, 2003

(51) Int. Cl. G06F 15/16

(52) U.S. Cl. 709/229

(57) ABSTRACT

A system including a plurality of localized networks within a generic network environment provides personalized services to subscribers by allowing the subscribers to tailor services via the localized network switches and their respective local network service providers. Having a large number of localized network service providers allows the system to provide subscriber-specific services that are germane to a geographic area or to a service specialty, e.g., medical, emergency, vacation, or education, which can be quickly introduced to a community of users and monitored closely. Also, the costs and complexities associated with a localized network service provider are much lower than those associated with a global Internet service provider (ISP). A plurality of localized Internet types of services are provided in the generic fixed network type of environment by users programming these localized Internets using the cheaper network service providers.

### FIELD OF THE INVENTION

The present invention is generally related to knowledge-based systems and more specifically related to localized knowledge-based intelligent networks for providing subscriber-specific services via any generic network.

### BACKGROUND

The array of personalized Internet services available to users via browsers is increasing. These Internet services attempt to satisfy the needs of the Internet users, however they do not particularly meet the specialized needs of most of the network service subscribers. The conventional telephone industry has attempted to provide services to subscribers via intelligent networks (INs) and advanced intelligent networks (AINs). Typically, the types of services are limited to a predefined set of services. The user has very little ability to tailor services. Meeting the increasing demand for personalized services has been difficult for several reasons. One reason is that the telephone networks are large, thus taking a relatively long time to update. Another reason is that standards take a long time to develop, approve, and implement. Standard interfaces and software modules needed to perform the new functions typically may not be readily available. Furthermore the existing backbone network typically requires extensive modifications to host the new updates.

### SUMMARY OF THE INVENTION

A method provides access to localized knowledge-based services. A signal is received via a network indicative of a request for a subscriber-specific service. The signal is processed by a local knowledge-based processing system containing information pertaining to the subscriber-specific service and configured to process requests pertaining to the subscriber-specific service. The local knowledge-based processing system is updated in accordance with results of the processing of the request. Access is provided to the subscriber-specific service.

### BRIEF DESCRIPTION OF THE DRAWINGS

In the drawings:

FIG. 1 is an illustration of a three-tiered embodiment of a localized knowledge-based intelligent network in accordance with the present invention;

FIG. 2 is a block diagram of an intelligent network illustrating the relationship between the service control point of the local service provider portion and a knowledge base in accordance with an embodiment of the present invention;

FIG. 3 is a block diagram of an exemplary intelligent network comprising subscriber-based processors in accordance with the present invention;

FIG. 4 is a block diagram of an embodiment of an intelligent network comprising a service provider-based knowledge database in accordance with the present invention; and

FIG. 5 is a diagram of the knowledge base of the service control point partitioned into a dynamic database and a static database in accordance with an embodiment of the present invention.

### DETAILED DESCRIPTION

U.S. Pat. No. 4,191,860 to Weber, U.S. Pat. No. 5,465,319, to Ahamed, U.S. Pat. No. 5,715,371 to Ahamed et al. and U.S. Pat. No. 6,272,481 to Lawrence et al. are expressly incorporated by reference as though set forth fully herein.

An example is described herein of a system and method for providing personalized services to any general network service subscribers, which can be tailored to meet the subscribers' needs. In one embodiment, a system including a plurality of localized networks provides personalized services to subscribers via the network switches by allowing the subscribers to tailor services via the localized networks and their respective local network service providers. The networked processing system includes a plurality of local knowledge-based processing systems. Each local knowledge-based processing system contains information pertaining to a respective subscriber-specific service. Each local knowledge-based processing system is specifically configured to process requests pertaining to a respective subscriber-specific service. The system also includes at least one local service provider. Each of the plurality of local knowledge-based processing systems is communicatively coupled to each other and the local service provider(s) for providing the subscriber-specific services and updating respective local knowledge-based processing systems in accordance with results of processing respective requests.

A localized knowledge-based intelligent network as described herein provides tailored, personalized, services to any generic service subscribers. These subscriber-specific services may include services such as locating organ donors, medical services, insurance services, sales services, financial services, and educational services, for example. In one embodiment, the localized knowledge-based intelligent network utilizes a plurality of local knowledge-based processing systems (knowledge machines) and at least one local service provider communicatively coupled to each other by circuit switched networks (or any network), the Internet or other public network, and/or wireless technology. Each local knowledge processing system is specifically configured to process a request for a respective subscriber-specific service. This localized knowledge based intelligent network provides means for large groups of personal, wireless, service networks to be integrated to co-exist independently within one larger wide area network, e.g., national, corporate, and government networks, as independent intelligent networks sharing the network infrastructure.

To facilitate an understanding of the localized knowledge-based intelligent network described herein, a list of abbreviations and acronyms is provided in Table 1.

TABLE 1

| | |
|---|---|
| AD | Adjunct |
| ADSL | Asymmetric Digital Subscriber Line |
| AIN | Advanced Intelligent Network |
| ASP | Adjunct Service Provider |
| CCAF | Call Control Access Function |
| CCF | Call Control Function |
| CCITT | Consultative Committee of International |
| | Telephone and Telegraph |
| DSL | Digital Subscriber Line |
| FC | Functional Component |
| IMIS | Intelligent Management Information Service |
| IN | Intelligent Network |
| INCM | Intelligent Network Conceptual Model |
| IP | Intelligent Peripheral |
| IP | Internet Protocol |
| ISDN | Integrated Services Digital Network |
| ISP | Internet Service Provider |
| IT | Information Technology |
| ITU | International Telecommunications Union |
| KB | Knowledge Base |
| KBN | Knowledge-based Network |
| LAN | Local Area Network |
| MIS | Management Information System |
| NID | Network Information Database |
| NRM | Network Resource Manager |
| PCN | Personal Communication Network |
| PCP | Personal Control Point |
| PCS | Personal Communication Service |
| PIN | Personal Intelligent Network |
| POTS | Plain Old Telephone Service |
| SCE | Service Creation Environment |
| SCEF | Service Creation Environment Function |
| SCEP | Service Creation Environment Point |
| SCF | Service Control Function |
| SCP | Service Control Point |
| SDF | Service Data Function |
| SDP | Service Data Point |
| SIP | Subscriber Intelligent Peripheral |
| SLI | Subscriber Loop Interface |
| SMAF | Service Management Access Function |
| SMAP | Service Management Access Point |
| SMF | Service Management Function |
| SMP | Service Management Point |
| SMS | Service Management System |
| SN | Service Node |
| SRF | Special Resource Function |
| SS7 | Signaling System 7 |
| SSCP | Service Switching and Control Point |
| SSLI | Subscriber Service Logic Interpreter |
| SSP | Service Switching Point |
| STP | Signal Transfer Point |
| TELCO | Telephone Company |
| TINA | Telecommunications Intelligent |
| | Network Architecture (European Environment) |
| TL | Trunk Line |
| TMN | Telecommunications Management Network |

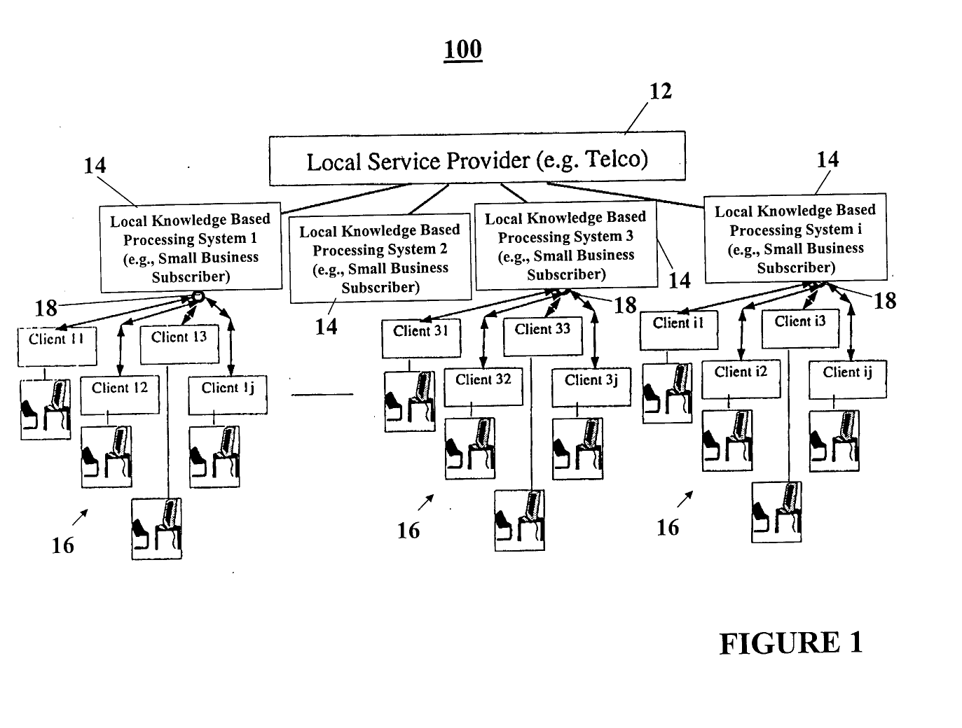

FIG. 1 shows a three-tiered embodiment 100 of a localized knowledge-based intelligent network. Network 100 comprises a first tier comprising at least one local service provider portion 12, a second tier comprising at least one local knowledge processing system 14, and a third tier comprising at least one subscriber portion (also referred to as a user or client portion) 16. Each local knowledge processing system 14, or a combination thereof, may comprise a localized Internet or ohter network using IP protocol. In accordance with this configuration, each local knowledge processing system 14 performs the functions of a local Internet service provider (ISP), and the network 100 functions as a plurality of localized Internets rather than one global Internet. Each local ISP facilitates providing subscriber-specific services to respective subscribers. For example, local service provider portion 12 may be under the operation of a large ISP or a telephone company, e.g., Verizon or AT&T. Local knowledge processing systems 14 may each be operated by a small business providing a subscriber-specific service having a knowledge database, e.g., location of organ donors, medical services, insurance services, sales services, financial services, educational services. In one embodiment, a subscriber gains access to the network 100 via subscriber portion 16 and the local knowledge processing system (or systems) 14 to which the subscriber subscribes. The subscriber may request information pertaining to the subscribed service or received periodic updates via signal(s) 18. The operator of the respective local knowledge processing system 14, e.g., small business, who in turn subscribes to services provided by the local service provider via local service provider portion 12, receives the signal 18 and provides the requested information (and/or updates) to the subscriber via signal 18 and subscriber portion 16, and updates its knowledge-based database (KBD) accordingly. The localized knowledge processor systems 14, also referred to as knowledge-based networks (KBNs), may also function interdependently with other KBNs 14, exchanging current information as it becomes available to perform a variety of functions, e.g., subscriber-specific services. Because the cost and complexity of a localized ISP is less than a global ISP, new participation at the local ISP level is fostered. More local services and businesses may participate, thus increasing competition and reducing customer costs.

Individual subscribers may access the network 100 via any appropriate technology, such as wireless, wireline, optical, electromagnetic, and Internet. A subscriber's access may be personalized by use of a subscriber access number, which is used to assign the subscriber a logical subscriber address indicative of the subscriber and the subscriber-specific service. The subscriber is assigned a logical address within the network 100, and for each KBN 14 to which that subscriber subscribes, the KBN 14 functions as a private intelligent network for that particular logical subscriber. The KBNs 14 function as personal intelligent networks (PINs) and personal communication networks (PCNs) for each subscriber. Accordingly, a subscriber has the privilege and freedom to force the network 100 to perform legitimate and ethically acceptable backbone network functions, such as providing a list of specialized services that can aid the subscriber to seek out specific information, and providing a list of alternatives to solutions to a specific problem being investigated by the subscriber, for example. In one embodiment the subscriber initiates and terminates a session with a KBN 14 for PIN services via wireless services based on a prepaid card.

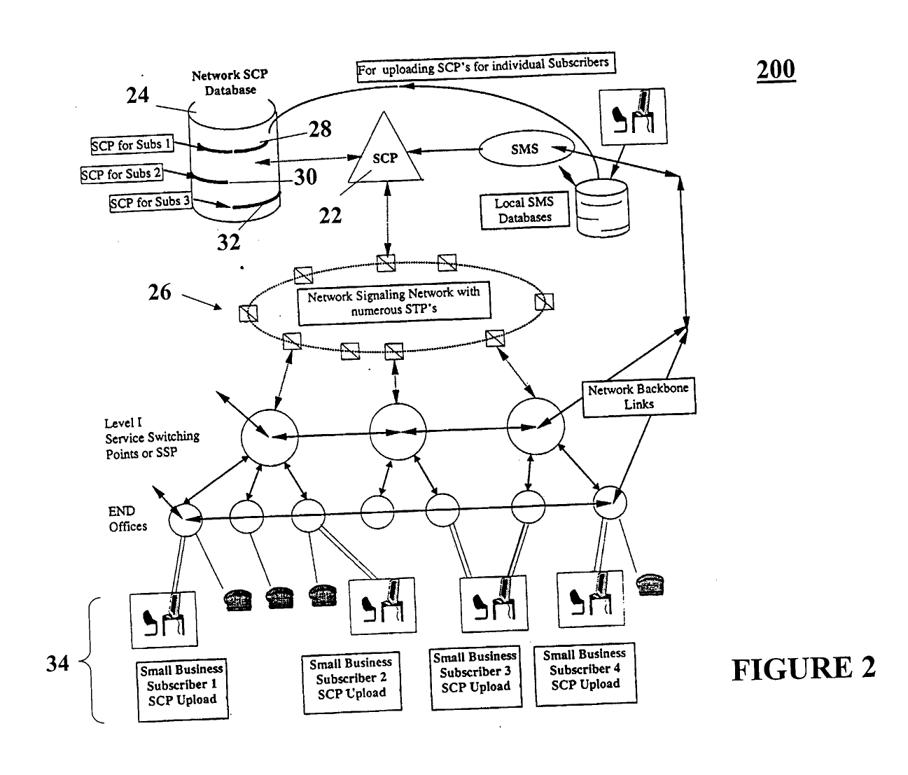

FIG. 2 is a block diagram of an intelligent network 200 illustrating the relationship between the service control point (SCP) 22 of the local service provider portion 12 and a knowledge base (KB) 24. The SCP 22 is a node in the telephone network 200, such as a signaling system 7 (SS7) telephone network, that provides an interface to databases, e.g., KB 24, which may reside within the SCP 22 processor or in other processors. The SCP 22 may also be combined with the signal transfer point (STP) 26. The STP 26 is a node in a telephone network that routes messages. The KB 24 supports telephone services such as 800 and 900 numbers, calling card validation, and collect and third-party billing calls. For cellular providers, KB 24 may contain subscriber information as well as information pertaining to other carrier's mobile customers accessing the IN 200.

The SS7 network uses a protocol common in the public switched telephone system (also referred to as the intelligent network (IN) or the advanced intelligent network (AIN)) for setting up calls and providing services. The SS7 network sets up and tears down a call, handles routing decisions and supports modern telephony services. Bellcore (now Telcordia) and the international telecommunications union (ITU) developed the IN. Bellcore named its initial versions ranging from the IN/I to AIN. The current Telcordia/Bellcore version of the IN is the AIN. Network Architecture has evolved as extensively as the Computer Architecture and all minor variations are possible. The AIN provides enhanced (compared to the earlier versions of IN) voice, video and data services and dynamic routing capabilities.

Referring again to FIG. 2, the SCP 24 of the intelligent network 200 is partitioned to accommodate a plurality of logical subscribers 34. Subscribers 34 are customers of the service provider. Subscribers 34 may be subscribers operating local knowledge processing systems 14, such as small businesses, individual subscribers, or a combination thereof. Each subscriber may subscribe to subscriber specific services, or have its own subscriber(s) subscribing to subscriber-specific services. Each subscriber may comprise a single or several logical subscribers. For example, a subscriber such as a university may subscribe to services for medical services and library services. For each of these two subscriber-specific services, the subscriber is treated, by the network, as a unique logical subscriber. Thus, the network provides medical services to one logical subscriber and library services to the other logical subscriber. In one exemplary embodiment, as depicted in FIG. 2, SCP portion 28 contains information pertaining to logical subscriber 1, SCP portion 30 contains information pertaining to logical subscriber 2, and SCP portion 32 contains information pertaining to logical subscriber 3. The SCP 24 may be partitioned physical and/or logically to accommodate storing and/or accessing logical subscriber information.

In one embodiment, the software needed to accommodate a logical subscriber resides on the SCP 24. This software may be activated by, for example, a new number series, e.g., 800, 888. Upon activation, the subscriber-specific services are provided to the logical subscriber. The scope of the subscriber-specific services may be limited by account parameters such as an authorized prepaid limit, and/or a predetermined limit, for example.

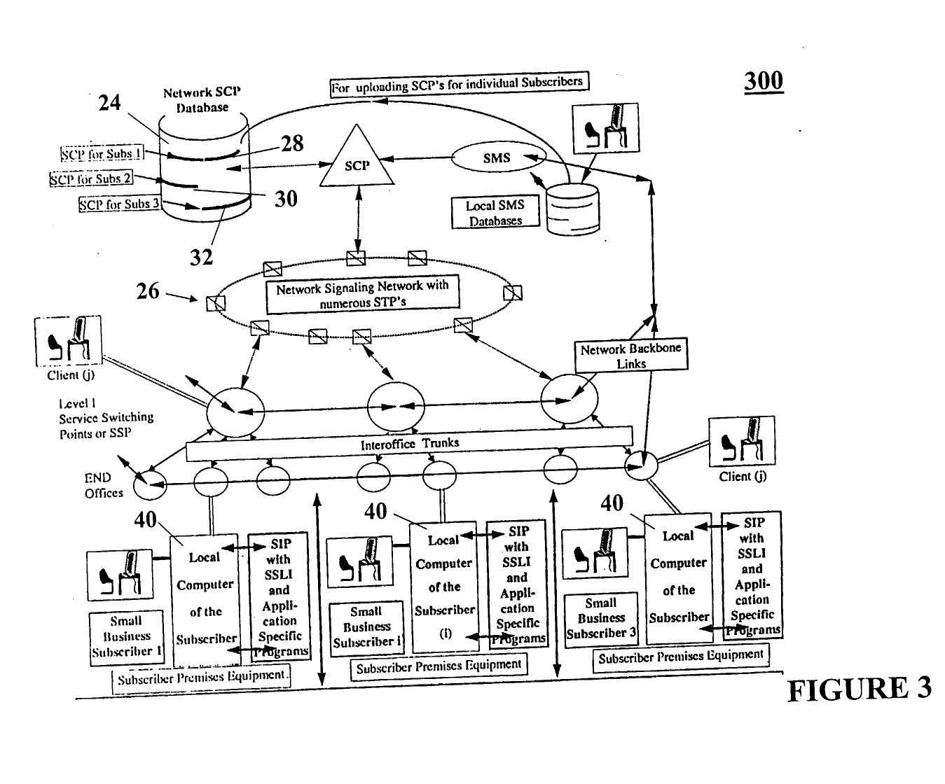

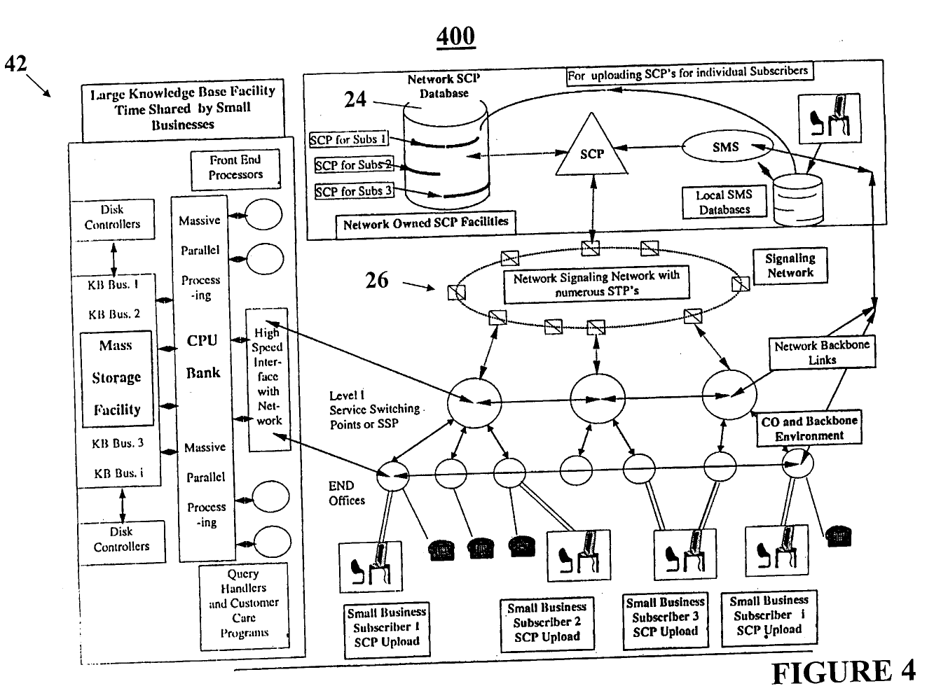

Other embodiments of the localized intelligent network are envisioned in which adjunct processors belonging to the service provider, the subscriber, or combination thereof, facilitate providing the subscriber-specific services. FIG. 3 depicts a network comprising subscriber processors and FIG. 4 depicts a network comprising service provider-based processors.

FIG. 3 is a block diagram of an embodiment of an intelligent network 300 comprising subscriber-based processors 40. The subscriber-based processors 40 facilitate the processing of the request for subscriber-specific services. Authorized network functions are accomplished by the subscribers via the subscriber-based processors 40. Examples of authorized network functions accomplished by subscriber-based processors 40 include identifying users and/or customers having authority to utilize the network, and parsing a query to validate the type of services being sought within the context of data stored in the specific files, e.g., 28, 30, 32, of the SCP network database 24. In an exemplary embodiment, the subscriber-based processor 40 comprises a subscriber intelligent peripheral (SIP) and a subscriber service logic interpreter (SSLI) to facilitate providing subscriber-specific services.

FIG. 4 is a block diagram of an embodiment of an intelligent network 400 comprising a service provider-based knowledge database (KB) 42. The network service provider, e.g., the telephone company, retains the KB 42, from which the subscriber-specific services are provided to the subscriber. The KB 42 effectively functions as a plurality, e.g., thousands, of Web-sites and their respective servers enabling the subscribers and clients to hop between a very large number of “Internet” sites now located at the telephone company premises via any private network. Integration of subscriber and network functions is accomplished by programs residing on the SCP 22 and KB 24. Alternatively, intelligent routers may share the functionality of the SCP 22 and KB 24 in other embodiments. This would reduce the programming effort to do the knowledge processing. These programs are customized and uploaded by the subscribers for their clients.

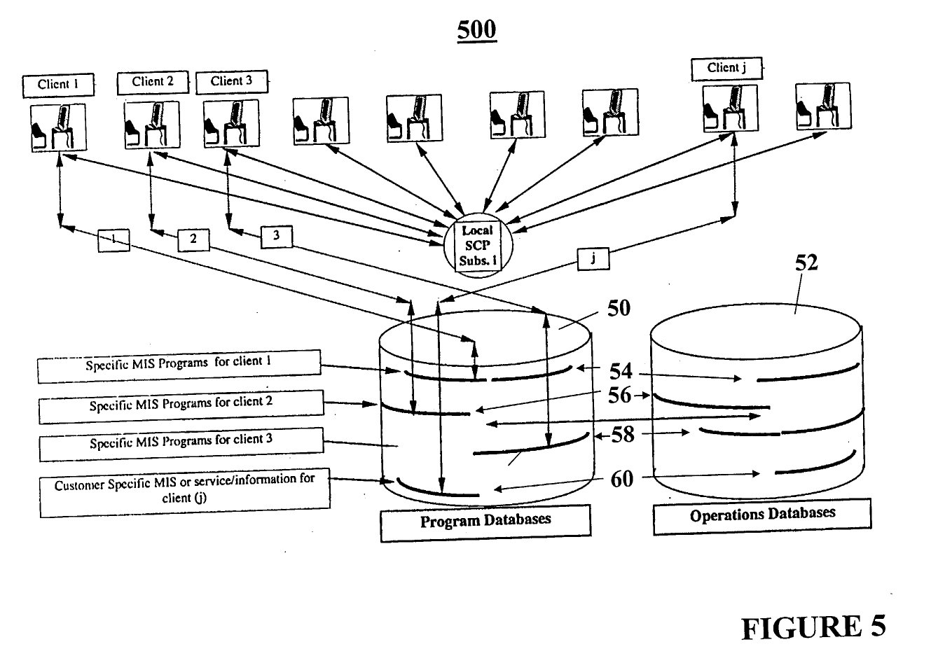

FIG. 5 shows the KB 24 of SCP 22 partitioned into a static database 50 and a dynamic database 52. This partitioning may be logical, physical, or a combination thereof. In this configuration, each subscriber retains its own specific portions of the KB 24, partitioned between the static database 50 and the dynamic database 52, as depicted by exemplary portion 54, 56, 58, and 60. Partitioning the KB 24 into databases 52 and 50 facilitates providing subscriber-specific services by storing dynamic information related to subscriber-specific services in the dynamic database 52 and storing static information related to subscriber-specific services in the static database 50. This configuration allows the network to respond more quickly to dynamic and temporal conditions. In one embodiment, static information includes subscriber-specific programs used to provide the subscriber-specific services, and dynamic information includes information used to respond to subscriber requests. Examples of static information stored in database 50 may include human resource functions such as payroll, benefits, vacation, and accounting procedural functions such as computation of daily sales, accounts receivable, accounts payable, profit margins, sales forecasts, and balance sheets. Examples of dynamic information stored in database 52 may include daily workforce reports, numbers of hours worked, sick leave, daily sales, revenue categories, and point of sales information. In one embodiment, the information in the dynamic database 52 is updated periodically and the programs in the static database 50 process this data immediately to obtain a relative fast and accurate perspective of a situation, such as monitoring security functions for a corporation, for example.

A localized knowledge-based intelligent network as described herein provides Internet and E-commerce features via any generic networks such as, for example, the circuit switched networks of the various telephone companies serving the local subscribers. The very large knowledge bases owned by the telephone companies can replace the thousands of small server environments (in any localized area) necessary for small businesses operating under the Internet (or other public network) environments. Subscribers may access and control services via prepaid cards and/or subscriptions. Knowledge-based services may be provided via the circuit switched networks. The system provides means for allowing small businesses to offer customized levels of sophistication for services provided to their customers. The costs associated with installing, running, maintaining, and updating each localized network is less than having a personal intelligent network dedicated for each subscriber base. Establishing and disestablishing services may be accomplished simply by software control via execution of network operating instructions. Sharing network resources reduces the initial cost per subscriber. The system provides commercial subscribers an alternative to having a web-site by directing incoming calls to their own private network designed and developed for the individual subscriber's needs.

The localized knowledge-based intelligent network as described herein may be embodied in the form of computer-implemented processes and apparatus for practicing those processes. The localized knowledge-based intelligent network as described herein may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The localized knowledge-based intelligent network as described herein may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although illustrated and described with reference to certain exemplary embodiments, the invention is not limited to the details shown. Rather, various modifications may be made by those skilled in the art within the scope and range of equivalents of the appended claims.

1. A method for providing access to localized knowledge-based services, the method comprising the steps of:
receiving a signal via a network indicative of a request for a subscriber-specific service;
processing the signal by a local knowledge processing system comprising information pertaining to the subscriber-specific service and configured to process requests pertaining to the subscriber-specific service;
updating the local knowledge processing system in accordance with results of the processing of the request; and
providing access to the subscriber-specific service.

2. A method in accordance claim 1, wherein the local knowledge processing system is communicatively coupled to other local knowledge processing systems and at least one local service provider via a at least one of the group consisting of a wireless network and a public network.

3. A method in accordance with claim 1, wherein the subscriber-specific service comprises at least one service selected from a group consisting of locating organ donors, medical services, insurance services, sales services, financial services, and educational services.

4. A method in accordance with claim 1, wherein the subscriber-specific service is provided by at least one of a group consisting of the local knowledge-base processing system, the local service provider, and a third party service provider.

5. A method in accordance with claim 1, further comprising:
processing the signal by a subscriber processor.

6. A method in accordance with claim 1, further comprising the steps of:
storing dynamic information related to the subscriber-specific service into a dynamic database; and
storing static information related to the subscriber-specific service into a static database.

7. A networked processing system for providing access to subscriber-specific services, the networked processing system comprising:
a plurality of local knowledge processing systems, wherein each local knowledge processing system:
stores information pertaining to a respective telephone service subscriber-specific service and is configured to:
process requests via a network pertaining to a respective subscriber-specific service;
update respective local knowledge processing systems in accordance with results of processing respective requests; and
provide access to the subscriber-specific services.

8. A system in accordance with claim 7, wherein:
the plurality of local knowledge processing systems are communicatively coupled to each other and at least one local service provider via the network and at least one of a group consisting of a wireless network and a public network.

9. A system in accordance with claim 7, wherein the subscriber specific services comprise at least one service selected from a group consisting of locating organ donors, medical services, insurance services, sales services, financial services, and educational services.

10. A system in accordance with claim 7, further comprising:
at least one third party service provider, wherein the subscriber-specific services are provided by at least one of a group consisting of the local knowledge base processing systems, the at least one local service provider, and the at least one third party service provider.

11. A system in accordance with claim 7, wherein at least one of the plurality of local knowledge processing systems comprises a static database for storing static information pertaining to a respective subscriber-tailor service and a dynamic database for storing dynamic information pertaining to a respective subscriber-tailor service.

12. A system in accordance with claim 7, further comprising:
at least one subscriber processor for processing requests for respective subscriber-specific services.

13. A system in accordance with claim 7, wherein networked processing system is reconfigurable and updateable.

14. A computer readable medium encoded with a computer program for directing a processor to provide access to localized knowledge-based services, the program code comprising:
a first code segment for causing the processor to receive a request for a subscriber-specific service via a network;
a second code segment for causing the processor to process the request by a local knowledge processing system comprising information pertaining to the subscriber-specific service and configured to process requests pertaining to the subscriber-specific service;
a third code segment for causing the processor to update the local knowledge base processing system in accordance with results of the processing of the request; and
a fourth code segment for causing the processor to provide access to the subscriber-specific service.

15. A computer readable medium in accordance with claim 14, wherein the local knowledge processing system is communicatively coupled to other local knowledge processing systems and at least one local service provider via the network and at least one of a group consisting of a wireless network and a public network.

16. A computer readable medium in accordance with claim 14, wherein:
the subscriber specific service comprises at least one service selected from a group consisting of locating organ donors, medical services, insurance services, sales services, financial services, and educational services.

17. A computer readable medium in accordance with claim 14, wherein the subscriber-specific service is provided by at least one of a group consisting of the local knowledge base processing system, the at least one local service provider, and a third party service provider.

18. A computer readable medium in accordance with claim 14, the program code further comprising:
a fifth code segment for causing the processor to process the request by a subscriber-based processor.

19. A computer readable medium in accordance with claim 14, the program code further comprising:
a sixth code segment for causing the processor to store information related to the subscriber-specific service into a dynamic database and a static database.

20. A knowledge processor for providing access to subscriber-specific services via a network, the local knowledge processor comprising:
a memory portion configured to store information pertaining to the subscriber-specific services;
a processing portion configured to:
process a request via the network pertaining to the subscriber-specific services;
update the memory portion in accordance with results of processing the request; and
provide access to requested subscriber-specific services.

21. A subscriber-based processor for facilitating access to subscriber-specific services via a network, the subscriber-based processor configured to:
process a signal via the network indicative of a request for a subscriber-specific service from a local knowledge processing system;
process a signal indicative of a response to the request; and
facilitate access to requested telephone service subscriber-specific services.
